(19) United States
(12) Patent Application Publication
(10) Pub. No.: US 2008/0181476 A1
(43) Pub. Date: Jul. 31, 2008

(54) SPECKLE SUPPRESSION IN ULTRASOUND IMAGING

(75) Inventors: Tuncer Can Aysal, Newark, DE (US); Kenneth E. Barner, Newark, DE (US)

Correspondence Address: RATNERPRESTIA, P.O. BOX 1596, WILMINGTON, DE, 19899, US

(73) Assignee: UNIVERSITY OF DELAWARE, Newark, DE (US)

(21) Appl. No.: 12/013,080

(22) Filed: Jan. 11, 2008

Related U.S. Application Data
(60) Provisional application No. 60/880,320, filed on Jan. 12, 2007.

(51) Int. Cl. G06K 9/00

(52) U.S. Cl. 382/128

(57) ABSTRACT

Methods and systems for enhancing an image exhibiting speckle noise are provided. An image exhibiting the speckle noise is received and a coefficient of variation is estimated in a part of the received image. Either a detail tuning parameter or a smooth tuning parameter are selected based on the estimated coefficient of variation. A maximum likelihood (ML) filter is configured with the selected tuning parameter and the configured ML filter is applied to the part of the received image.

### CROSS REFERENCE TO RELATED APPLICATIONS

This application is related to and claims the benefit of U.S. Provisional Application No. 60/880,320 entitled SPECKLE SUPPRESSION IN ULTRASOUND IMAGING filed on Jan. 12, 2007, the contents of which are incorporated herein by reference.

### FIELD OF THE INVENTION

The present invention relates to the field of ultrasound imaging and, more particularly, to methods and systems for enhancing images exhibiting speckle noise.

### BACKGROUND OF THE INVENTION

Ultrasound imaging is a widely used medical diagnostic technique. For instance, the use of ultrasound in the diagnosis and assessment of arterial disease is well established because of its noninvasive nature, its low cost, and the continuing improvements in image quality. During imaging, a transmitted ultrasound signal penetrates and interacts with the human body, and information about internal tissue structures is encoded in the backscatter. The backscatter is randomly disturbed in the resolution cell of a sensor, causing ultrasound images to exhibit granular patterns of white and dark spots that are commonly referred to as speckle noise.

Speckle noise limits the contrast resolution in diagnostic ultrasound imaging, making ultrasound images difficult for nonspecialists to interpret. Further, even ultrasound specialists may be unable to draw useful conclusions from images exhibiting speckle.

Conventional despeckling filters typically reduce the effect of speckle noise through smoothing of the image. These filters, however, are sensitive to noise. Techniques for attenuating noise may not be adequate to enable conventional filters to generate suitable ultrasound images, especially in the smooth and background areas of the ultrasound image.

### SUMMARY OF THE INVENTION

The present invention is embodied in a method for enhancing an image exhibiting speckle noise. The method includes a) receiving the image exhibiting the speckle noise, b) estimating a coefficient of variation in a part of the received image, c) selecting either a detail tuning parameter or a smooth tuning parameter based on the estimated coefficient of variation, d) configuring a maximum likelihood (ML) filter with the selected tuning parameter and e) applying the configured ML filter to the part of the received image.

The present invention is also embodied in a system for enhancing an image exhibiting speckle noise. The system includes an input port configured to receive the image exhibiting the speckle noise. The received image includes a plurality of parts. The system also includes an estimator configured to estimate coefficients of variation corresponding to the parts of the image received from the input port, and a storage configured to store a detail tuning parameter and a smooth tuning parameter. The system further includes a maximum likelihood (ML) filter configured to filter each of the parts of the received image exhibiting the speckle noise. The ML filter is configured for each of the parts of the received image based on a selected tuning parameter. The system further includes a processor configured to select, for each of the parts of the received image, either the detail tuning parameter or the smooth tuning parameter from the storage as the selected tuning parameter based on the corresponding estimated coefficients of variation received from the estimator and to configure the ML filter with the selected tuning parameter. The configured ML filter filters the received image to enhance the received image.

### BRIEF DESCRIPTION OF THE DRAWINGS

The invention is best understood from the following detailed description when read in connection with the accompanying drawings. It is emphasized that, according to common practice, various features/elements of the drawings may not be drawn to scale. On the contrary, the dimensions of the various features/elements may be arbitrarily expanded or reduced for clarity. Moreover, in the drawings, common numerical references are used to represent like features/elements. Included in the drawing are the following figures:

FIG. 1 is a functional block diagram illustrating an exemplary system for enhancing an image exhibiting speckle noise, according to an embodiment of the present invention;

FIG. 2A is a flowchart illustrating an exemplary method for enhancing a part of a received image that exhibits speckle noise, according to an embodiment of the present invention;

FIG. 2B is a flowchart illustrating an exemplary method for enhancing the received image that exhibits speckle noise, according to an embodiment of the present invention;

FIG. 3 is a flowchart illustrating an exemplary method for selecting a tuning parameter for a part of the received image based on an estimated coefficient of variation, according to an embodiment of the present invention;

FIG. 4 is a flowchart illustrating an exemplary method for configuring an exemplary ML filter with a spatial weighting, according to an embodiment of the present invention; and

FIG. 5 is a graph of output variances of various ML filters including an exemplary multiplicative modeled ML filter, illustrating noise attenuation capabilities of the various ML filters;

FIG. 6 is a graph of an output mean of various ML filters including an exemplary multiplicative modeled ML filter, further illustrating noise attenuation capabilities of the various ML filters;

FIGS. 7A, 7B, 7C, 7D, 7E, 7F, 7G, 7H are images illustrating a despeckling performance of various ML filters including an exemplary multiplicative modeled ML filter on a blood image including simulated speckle noise;

FIG. 8 is an image of obstetrical ultrasound data including speckle noise;

FIGS. 9A, 9B, 9C, 9D, 9E, 9F, 9G, 9H are images illustrating a despeckling performance of an exemplary multiplicative modeled ML filter with various tuning parameters on the image shown in FIG. 8;

FIGS. 10A, 10B, 10C, 10D, 10E, 10F, 10G, 10H are enlarged portions of the respective images shown in FIGS. 9A-9H;

FIGS. 11A, 11B, 11C, 11D, 11E, 11F, 11G, 11H are images illustrating a despeckling performance of various ML filters including an exemplary multiplicative modeled ML filter on the image shown in FIG. 8;

FIGS. 12A, 12B, 12C, 12D, 12E, 12F, 12G, 12H are enlarged portions of the respective images shown in FIGS. 11A-11H;

FIGS. 13A, 13B, 13C, 13D, 13E, 13F, 13G, 13H are graphs of one scan column of the images shown in FIGS. 11A-11H;

FIGS. 14A, 14B, 14C, 14D, 14E, 14F, 14G, 14H are images illustrating a despeckling performance of various ML filters including an exemplary multiplicative modeled ML filter on high resolution ultrasound data;

FIGS. 15A, 15B, 15C, 15D, 15E, 15F, 15G, 15H are images illustrating a despeckling performance of various ML filters including an exemplary multiplicative modeled weighted ML filter on the image shown in FIG. 8;

FIGS. 16A, 16B, 16C, 16D are images illustrating a despeckling performance of various ML filters including an exemplary additive modeled ML filter on a blood image including simulated speckle noise; and

FIGS. 17A, 17B, 17C, 17D, 17E, 17F, 17G, 17H are images illustrating a despeckling performance of various ML filters including an exemplary additive modeled ML filter on the image shown in FIG. 8.

### DETAILED DESCRIPTION OF THE INVENTION

The present invention describes systems and methods for enhancing an image exhibiting speckle noise. First, a summary of exemplary systems and methods of the present invention is provided. Second, exemplary systems for enhancing an image exhibiting speckle noise are provided. Third, exemplary methods for enhancing an image exhibiting speckle noise are provided. Fourth, a description of exemplary tuning parameter selection is provided. Fifth, a description of spatially weighted configurations of an exemplary maximum likelihood (ML) filter is provided. Sixth, models of speckle noise are provided. Seventh, derivations of exemplary ML filters are provided. Eighth, examples of the performance of exemplary ML filters are provided.

As a general overview, the present invention is directed to enhancing an image that exhibits speckle noise. A coefficient of variation may be estimated from a part of the received image and used to select either a detail tuning parameter or a smooth tuning parameter. A ML filter may be configured with the selected tuning parameter and applied to a part of the received image. The process may then be repeated for at least one other part of the received image, thereby enhancing the received image. In a further embodiment, the ML filter may be configured with a spatial weighting based upon a correlation among samples of a part of the received image. Exemplary systems and methods, according to the present invention, provide noise attenuation in background/smooth areas and enhancement in edge/detail areas. Thus, the present invention is capable of reducing speckle noise and jointly enhancing edge information in a cost-effective fashion.

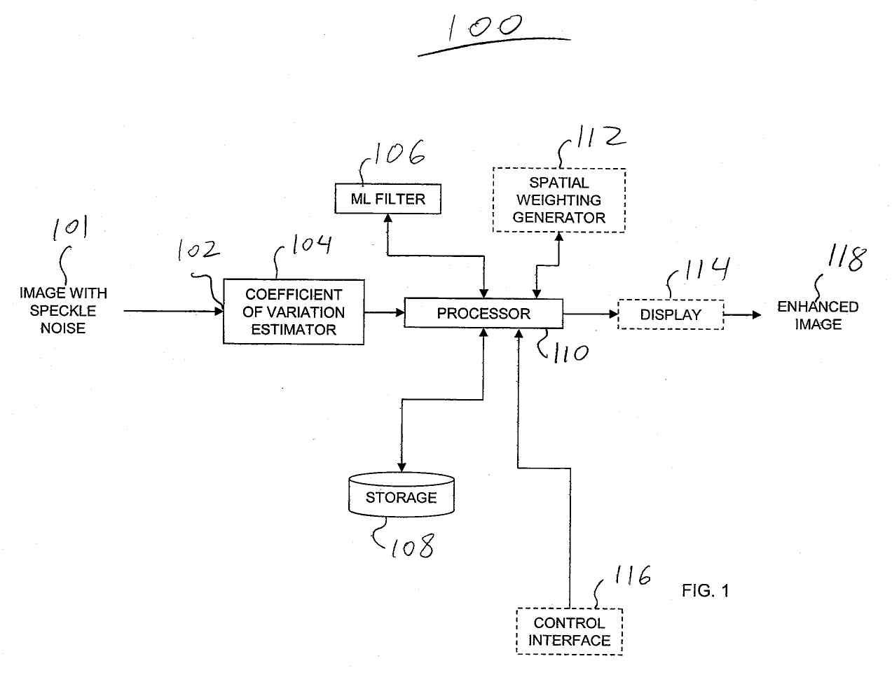

An exemplary system will now be described with reference to the individual figures. FIG. 1 is a functional block diagram illustrating an exemplary system 100 for enhancing an image 101 exhibiting speckle noise. The illustrated system 100 includes an input port 102 configured to receive the image 101 exhibiting speckle noise, a coefficient of variation estimator 104, a maximum likelihood (ML) filter 106, storage 108, and a processor 110.

Input port 102 may be essentially any suitable interface capable of receiving the image 101. As described below, the received image 101 may be a signal carrying an image including a plurality of parts representing different observation windows of the received image 101.

Processor 110 may be a conventional digital signal processor that enhances images exhibiting speckle noise using an algorithm in accordance with the subject invention. System 100 may include other electronic components and software suitable for performing at least part of the functions of generating and enhancing the received image.

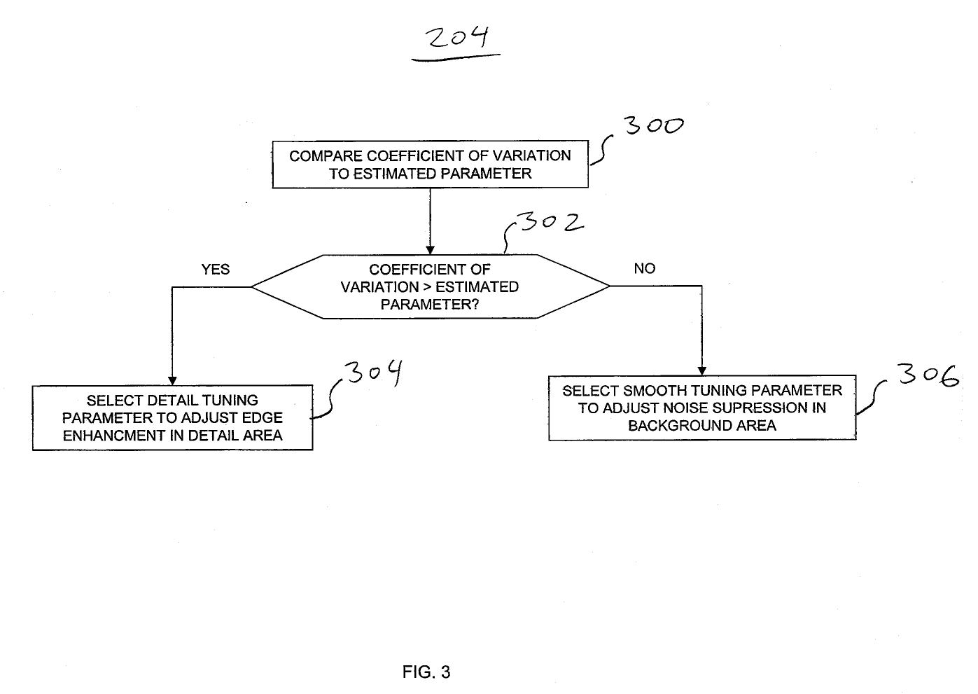

Coefficient of variation estimator 104 desirably receives the image 101 from input port 102 and estimates coefficients of variation corresponding to the parts of the received image. Each coefficient of variation may provide local image statistics corresponding to a part of the received image and thus estimate a terrain reflectivity. In an example embodiment, two classes of terrain reflectivity are considered; a homogeneous class and a heterogeneous class. A part of an image free of speckle noise may be represented by f(i, j), where i and j indicate the location of pixels within the part within the image. The homogeneous class corresponds to image parts where the noise-free image f(i, j) is constant, such as in smooth and background areas, and the heterogeneous class corresponds to image parts where f(i, j) varies, such as in textured areas, along edges, and in the presence of details. The coefficient of variation, thus, may be used to determine whether the part of the image represents a detail area (a heterogeneous area) or a background area (a homogeneous area). The coefficient of variation is described further below with respect to FIG. 3. Other techniques for identifying detail areas and background areas will be understood by one of skill in the art from the description herein.

ML filter 106 is desirably configured to filter each of the parts of the received image 101 exhibiting speckle noise. The ML filter 106 may include a robust maximum likelihood multiplicative-modeled filter (R_ML_{MUL}) and/or a robust maximum likelihood additive-modeled filter (R-ML_{ADD}), which are described in detail below. ML filter 106 may be configured for each of the parts of the received image based on a selected tuning parameter, described below. Note that the expressions “ML filter” and “ML estimator” are used interchangeably herein.

Storage 108 may store a detail tuning parameter (for heterogeneous areas) and a smooth tuning parameter (for homogeneous areas) for use in configuring the ML filter. Storage 108 may be a memory, a magnetic disk, a database or essentially any local or remote device capable of storing data.

Processor 110 may be configured to select the detail tuning parameter or the smooth tuning parameter from storage 108 for each of the parts of the received image 101. The processor 110 may select the tuning parameter based on the corresponding estimated coefficients of variation received from estimator 104. The processor 110 may then configure the ML filter 106 with the selected tuning parameter retrieved from storage 108. Thus, the ML filter 106, as configured by the processor 110, may filter each of the parts of the received image 101 to enhance the received image, forming enhanced image 118.

The ML estimator for both the multiplicative and additive models reduces to a minimum (min) filtering operation as a general tuning parameter, α, (representing both α_{MUL} and α_{ADD} for the respective multiplicative-modeled and additive-modeled ML filters, described in detail below) tends to infinity (∞) and reduces to a maximum (max) filtering operation as, α, tends to 0. In ultrasound images, image features are generally represented by bright regions that correspond to large pixel values representing high levels of reflectivity. Thus, the noise components in these regions are most likely manifested as small valued pixels, motivating a max filtering operation. A max filtering operation may also enhance image details, because bright regions will tend to be brightened by the max operation. The background in ultrasound images are, in contrast, represented by dark regions that correspond to small pixel values representing low levels of reflectivity. The noise components, in this case, are manifested as larger valued pixels, as compared to the detail image features, motivating a min filtering operation. According to an embodiment of the present invention, the exemplary ML filter 106 may be tuned to obtain a max filtering operation in detail areas (by selecting the detail tuning parameter) and a min filtering operation in smooth background areas (by selecting the smooth tuning parameter).

System 100 may optionally include a spatial weighting generator 112 for generating a spatial weighting corresponding to samples in at least one part of the received image. Nonnegative weights {h(i, j)} may be assigned to the input samples (observations) {g(i, j):(i, j)∈Ω}, where the weights can be interpreted as reflecting the varying levels of sample “reliability,” where Ω represents the observation window and where g(·, ·) represents the received noisy image 101. In an exemplary embodiment, the observations are assumed to be independent Rayleigh random variables that may not be identically distributed.

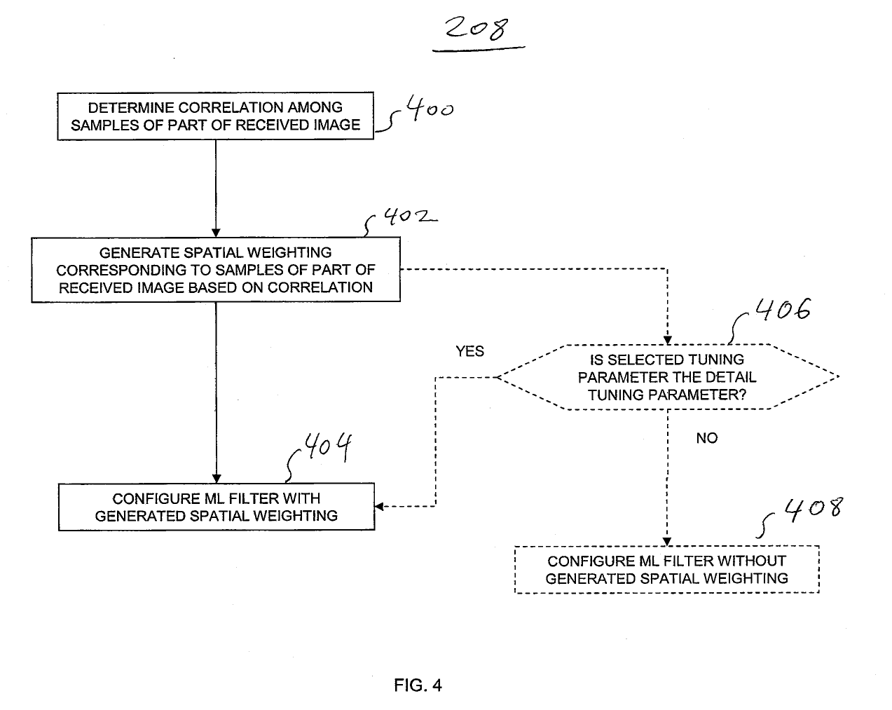

In an exemplary embodiment, modeling the input samples with varying weighting leads to different weights (reliabilities) that effectively account for temporal/spatial correlations. Thus, the spatial weighting generator 112 may generate a spatial weighting based upon a correlation among the respective samples in one or more parts of the received image 101. Accordingly, processor 110 may configure ML filter 106 with the spatial weighting for at least one part of the received image 101. A further description of the spatial weighting is described below with respect to FIG. 4.

System 100 may optionally include a display 114 configured to display the detail tuning parameter, the smooth tuning parameter, the spatial weighting, the received image 101 and/or the filtered (enhanced) image 118. It is contemplated that parts of the received image 101 that are enhanced may be stored in storage 108 during the processing of the entire image and that the enhanced image 118 may be provided to processor 110, for example, to be displayed on display 114. It is understood that the enhanced image 118 may be provided to display 114 via ML filter 106. It is contemplated that display 114 may include any display capable of presenting information including textual and/or graphical information.

System 100 optionally includes a control interface 116, e.g., for use in adjusting the detail tuning parameter, the smooth tuning parameter and/or the spatial weighting via processor 110. Control interface 116 may further be used to select parameters and/or images to be displayed and/or stored. The control interface 116 may include a pointing device type interface for selecting control parameters using display 114. Control interface 116 may further include a text interface for entering information, for example, a filename for storing the received image 101 and/or the enhanced image 118, such as in storage 108 or in a remote device (not shown). Accordingly, an exemplary system 100 may allow a user to adjust, for example, the detail tuning parameter in order to refine edge enhancement of the received image 101 and/or the smooth tuning parameter in order to provide noise suppression of the received image 101.

It is contemplated that system 100 may be configured to connect to a global information network, e.g. the Internet, (not shown) such that the enhanced image 118 may also be transmitted to a remote location for further processing and/or storage.

A suitable input terminal 102, coefficient of variation estimator 104, ML filter 106, storage 108, processor 110, spatial weighting generator 112, display 114 and control interface 116 for use with the present invention will be understood by one of skill in the art from the description herein.

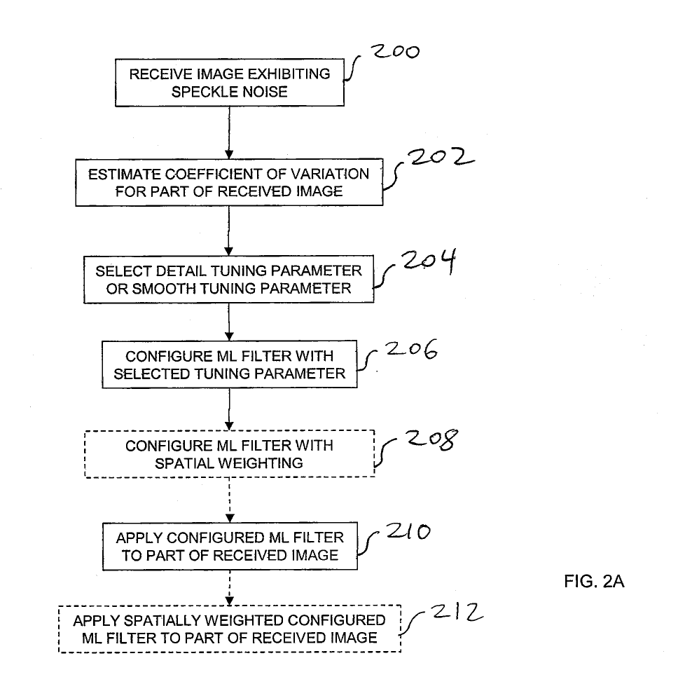

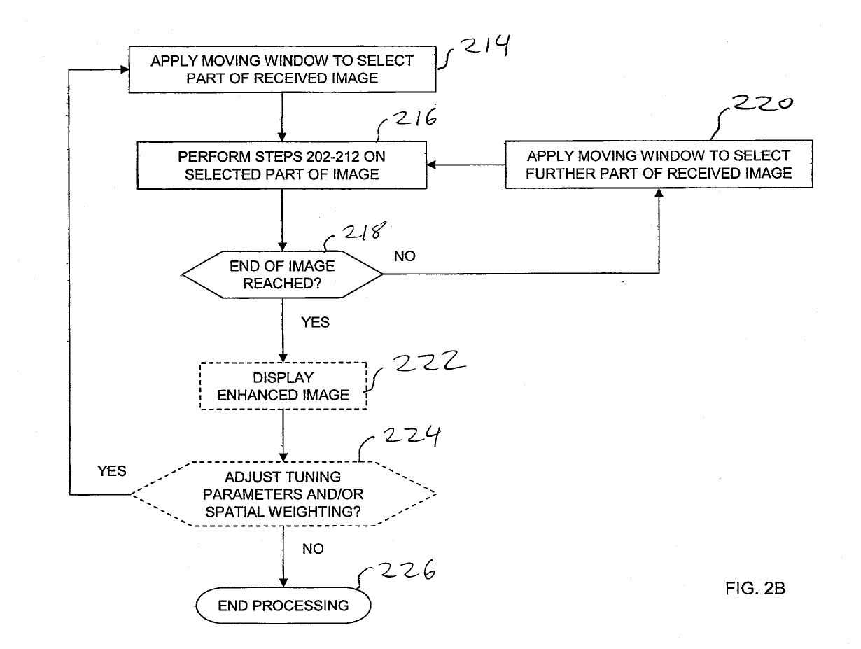

FIGS. 2A and 2B depict flowcharts illustrating exemplary methods for enhancing an image exhibiting speckle noise, according to an embodiment of the present invention. More particularly, FIG. 2A is a flowchart illustrating an exemplary method for enhancing a part of a received image that exhibits speckle noise, and FIG. 2B is a flowchart illustrating an exemplary method for enhancing the received image that exhibits speckle noise over the entire image.

Referring to FIG. 2A, in step 200, the image 101 exhibiting speckle noise is received, for example at input port 102 (FIG. 1). In step 202, a coefficient of variation is estimated for a part of the received image signal, for example, by coefficient of variation estimator 104 (FIG. 1). The coefficient of variation provides an indication of whether the part of the received image signal is a detail area or a background area. In step 204, either a detail tuning parameter α_{E} or a smooth tuning parameter α_{S} is selected, for example, from storage 108 by processor 110 (FIG. 1), based on the estimated coefficient of variation (described in detail below with respect to FIG. 3). In an exemplary embodiment, the detail tuning parameter is selected for edge areas and the smooth tuning parameter is selected for background areas.

In step 206, a ML filter, for example, ML filter 106 (FIG. 1) is configured with the tuning parameter selected in step 204. In optional step 208, an exemplary ML filter may be configured with a spatial weighting, for example, by configuring ML filter 106 using spatial weighting generator 112 and processor 110 (FIG. 1). In step 210, the ML filter configured in step 206 is applied to the part of the received image, which is described in detail below. In optional step 212, the spatially weighted configured ML filter may be applied to the part of the received signal. In this manner, a part of the received image may be filtered by an exemplary ML filter, for example, the R-ML_{MUL} filter, the R-ML_{ADD} filter, or a weighted R-ML_{MUL} filter (described further below with respect to FIG. 4).

Referring to FIG. 2B, in step 214, a moving window is applied to the received image in order to select other parts (observation windows) of the received image. For example, processor 110 may position a moving window (not shown) over respective parts of the received image (FIG. 1). In step 216, steps 202-212 (FIG. 2A) are performed on a selected part of the image. In step 218, it is determined whether the end of the image is reached. If the end of the image is reached, step 218 proceeds to optional step 222. If the end of the image is not reached, step 218 proceeds to step 220.

In step 220, a moving window is applied to another selected part of the received image. Step 220 proceeds to step 216 and processing continues with steps 216, 218 and 220 until the end the image is reached in step 218. Application of the moving window over parts of the received image will be understood by one of skill in the art from the description herein.

In optional step 222, the enhanced image 118 is displayed, e.g. on display 114 (FIG. 1). In optional step 224, it is determined whether the tuning parameters, i.e. the detail tuning parameter and the smooth tuning parameter, and/or the spatial weighting should be adjusted. For example, a user may review the enhanced image 118 on display 114 (FIG. 1) and determine that one or more of the tuning parameters and/or the spatial weighting should be adjusted. The control interface 116 may be used to provide adjusted tuning parameters and/or spatial weighting to processor 110 (FIG. 1) in order to update the respective tuning parameters and/or spatial weighting.

If the tuning parameters and/or spatial weighting are adjusted, step 224 proceeds to step 214 and processing continues as described above. If the tuning parameters and/or spatial weighting are not adjusted, optional step 224 proceeds to step 226 and the process is complete. Step 218 may proceed to step 226, to complete the process without performing optional steps 222 and 224.

FIG. 3 depicts a flowchart illustrating an exemplary method for selecting a tuning parameter, step 204 in FIG. 2A, for a part of the received image based on the estimated coefficient of variation. In step 300, the coefficient of variation, C, for a part of the received image is compared to an estimated parameter, such as an estimated square root of the variance of a fading variable, η (described in detail below). A comparison of the coefficient of variation, C, to an exemplary estimated parameter is now described.

The coefficient of variation, C, can be denoted as:

$$C = \frac{\sqrt{Var ( g )}}{{γ}_{g}} \qquad ( 1 )$$

As discussed above, the heterogeneous and homogenous classes of terrain reflectivity can be estimated from the coefficient of variation. The relationship between the coefficient of variation and the variance of the fading variable is described below.

The mean of the received noisy image, g(i,j) may be given by:

γ_{g}=γ_{f}γₙ=γ_{f} (2)

because γ_{η}=1 and f and η are uncorrelated, where γ denotes the mean of the corresponding variable. The variance of the received noisy image g may be obtained as:

Var(g)=E(f²)E(η²)−(γ_{f})²(γ_{η})² (3)

If the terrain reflectivity has a constant average intensity, E{f²}=γ_{f}², then the standard deviation to mean ratio of g(i,j) may be given by:

$$\frac{\sqrt{Var ( g )}}{{γ}_{g}} = \sqrt{Var ( η )} \qquad ( 4 )$$

If the terrain reflectivity varies, then the following holds:

$$\frac{\sqrt{Var ( g )}}{{γ}_{g}} > \sqrt{Var ( η )} \qquad ( 5 )$$

Thus, the terrain reflectivity homogeneity can be estimated from the coefficient of variation C.

Accordingly, the following classification of terrain reflectivity may be introduced:
C≦\sqrt{Var(η)} [symbol] Homogenous Area
C>\sqrt{Var(η)} [symbol] Heterogeneous Area
   where Var(η) may be estimated by calculating the variance over a constant region in the received image. In an exemplary embodiment, the coefficient of variation, thus, may be compared to the square-root of the estimated Var(η), in step 300. It is contemplated that the coefficient of variation may be compared to other parameters estimated over a region of the received image.

In step 302, it is determined whether the coefficient of variation is greater than the estimated parameter, for example, by processor 110 (FIG. 1). If the coefficient of variation is greater than the estimated parameter, it is determined that the received image part represents a detail (heterogeneous) area and step 302 proceeds to step 304. If the coefficient of variation is less than or equal to the estimated parameter, it is determined that the received image part represents a background (homogeneous) area and step 302 proceeds to step 306.

In step 304, which is reached if it is determined that the received image part represents a detail (heterogeneous) area, the detail tuning parameter, α_{E}, is selected, for example, by processor 110 (FIG. 1).

In step 306, which is reached if it is determined that the received image part represents a background (homogeneous) area, the smooth tuning parameter, α_{S}, is selected, for example, by processor 110 (FIG. 1).

As described above, an exemplary R-ML_{MUL} filter and an exemplary R-ML_{ADD} filter tends to a max filter operation when the tuning parameter tends to zero and to a min filter operation when the tuning parameter tends to ∞. Accordingly, the tuning parameter may be spatially adapted, in each observation window, utilizing instantaneous image statistics, with the results being max filtering in detail areas and min filtering in smooth regions. The tuned R-ML estimator is desirably advantageous in applications where significant noise suppressing and contrast enhancement is favored.

The tuning parameter discussed above enables the exemplary filter performance to be tailored to the general homogeneous and heterogeneous cases. Additionally, spatial weighting may be used to further configure the ML filter, which is described below, to handle more demanding or specialized cases. For example, some ultrasound images may exhibit directional noise, causing the speckle noise to appear in arc forms. Accordingly, an appropriate designed spatial weighting may be applied to these cases of directional noise.

FIG. 4 is a flowchart illustrating an exemplary method for configuring an exemplary ML filter with a spatial weighting, step 208 in FIG. 2A. In step 400, a correlation among samples of a part of the received image is determined, for example, by spatial weighting generator 112 (FIG. 1). In step 402, a spatial weighting is generated corresponding to samples in a part of the received image based on the correlation determined in step 400, for example, by spatial weighting generator 112 (FIG. 1).

Modeling the input samples with varying scale factors, leads to different weights (reliabilities) that effectively account for temporal/spatial correlations. A larger weight value makes the corresponding distribution more concentrated, thereby increasing the reliability of the sample.

In step 404, the ML filter is configured with the generated spatial weighting, for example, by processor 110 (FIG. 1). A derivation of an exemplary multiplicative-modeled ML filter configured with the generated spatial weighting (weighted R-ML_{MUL} filter) is provided below.

Consider the multiplicative fully developed speckle model for small window Ω:

g(i,j)≈βη(i,j), ∀(i,j)∈Ω (6)

where, in this case, each fading variable η(i,j) may have different scale parameters σ_{η}(i,j). That is, σ_{η}(i,j) may be defined as:

$${σ}_{η} ( i , j ) = \frac{{σ}_{η}}{\sqrt{h ( i , j )}} \qquad ( 7 )$$

where σ_{η} is a nominal scale factor. Note that the special case of uniform unity weights corresponds to the unweighted case at the nominal scale factor σ_{η}. For the more general case, the probability density function of η(i,j) may be given by:

$${ψ}_{η} ( η ( i , j ) ) = \frac{η ( i , j )}{{σ}_{η}^{2} ( i , j )} exp ( - \frac{{η}^{2} ( i , j )}{2 {σ}_{η}^{2} ( i , j )} ) \qquad ( 8 )$$

The g(i,j) are, in this case, Rayleigh distributed with parameters σ_{g}(i,j)=βσ_{η}(i,j),

$${ψ}_{g} ( g ( i , j ) ) = \frac{g ( i , j )}{{β}^{2} {σ}_{η}^{2} ( i , j )} exp ( - \frac{{g}^{2} ( i , j )}{2 {β}^{2} {σ}_{η}^{2} ( i , j )} ) \qquad ( 9 )$$

The likelihood function for the varying parameter case is formulated as ψ_{g}(g|β), where g denotes the pixel values in the moving window arranged in a vector format. The ML solution in this case may be given by:

\hat{β}=arg max_{β}ψ_{g}(g|β) (10)

It can then be shown that the solution for the weighted estimator is:

$$Weighted R \text{-} {ML}_{MUL} Filter = {( \frac{1}{2 ‖ Ω ‖ {σ}_{η}^{2}} {\sum }_{( i , j ) ∈ Ω} h ( i , j ) {g}^{2} ( i , j ) )}^{1 / 2} \qquad ( 11 )$$

where the relationships σ_{η}(i,j)=σ_{η}/\sqrt{h(i,j)} and \hat{f}(i,j)=\hat{β} are used. Accordingly, the weighted R-ML_{MUL} filter may rely more on samples exhibiting smaller spread parameters and less on samples exhibiting larger spread parameters.

Referring back to FIG. 4, in optional step 406, it is determined whether the selected tuning parameter in step 204 (FIG. 2A) is the detail tuning parameter, α_{E}. If the selected tuning parameter is the detail tuning parameter, optional step 406 proceeds to step 404 and the ML filter is configured with the spatial weighting (to form the weighted R-ML_{MUL} filter).

If the selected tuning parameter is not the detail tuning parameter (i.e., it is the smooth tuning parameter α_{S}), optional step 406 proceeds to optional step 408. In step 408, the ML filter is configured without the generated spatial weighting (i.e., the ML filter is configured as the R-ML_{MUL} filter) generated in step 402. Accordingly, optional steps 406 and 408 reduce to an exemplary R-ML_{MUL} filter in homogenous areas to provide the most noise attenuation, and to an exemplary weighted R-ML_{MUL} filter in heterogeneous areas, to preserve image details. The performance of the spatially weighted ML filter may be further enhanced utilizing varied α_{S} and α_{E} values.

The introduction of spatial weights in an exemplary embodiment enables correlations among input samples to be exploited. This is desirable, for example, when the image has directional information that is to be preserved or enhanced. A tuned ML filter may be more advantageous where significant noise suppression and contrast enhancement is favored.

The ML filter yields better noise attenuation and edge enhancement than conventional methods. It is also noted that an exemplary ML filter, according to aspects of the present invention, is computationally efficient, using simple multiplication, addition, and square-root operations. In addition, tuning parameters and/or spatial weighting of an exemplary ML filter may be locally adjusted within the received image and also adjusted by a user, making the exemplary ML filter suitable for the varying characteristics of ultrasound images.

The exemplary systems and methods of the present invention may jointly suppress the speckle noise and enhance the image to the user's flexibility. The exemplary weighted and unweighted filtering methodologies are able to exploit varying characteristics of ultrasound images. In addition, because the computational complexity of the exemplary methodology is very low, the ultrasound specialist may vary the adaptive parameters online to evaluate the varying characteristics of the image and to better diagnose the image with the appropriate parameters. It is contemplated that the methods and systems described herein may be provided with ultrasound imaging products, for example, for clinical or industrial use.

A known filter for despeckling uses conventional maximum a posteriori (MAP) based algorithms. Many MAP based algorithms are derived for multiplicative noise models in synthetic aperture radar (SAR) images. However, not all of the MAP based algorithms may be suitable for application to ultrasound images. Furthermore, MAP based algorithms require a model of the original signal (i.e. the uncorrupted signal). Although it is known that speckle noise may be modeled by the Rayleigh probability density function (pdf), there are many unjustified models for the original signal, where experimental results may show a poor approximation with the unjustified models. The exemplary ML filters of the present invention, however, do not include any assumptions regarding the original signal model and adapts the image using the coefficient of variation in order to detect the input signal. In addition, MAP based algorithms typically do not have weighting or adaptive capabilities. The present invention, as discussed above, can provide spatial weighting and local adjustment of tuning parameters within the received image.

The present invention describes exemplary systems and methods for enhancing an ultrasound image exhibiting speckle noise. It is well-established that the SAR and magnetic resonance imaging (MRI) images may also be corrupted by multiplicative noise characterized with a density function. Accordingly, the exemplary systems and methods of the present invention may be applied to SAR and MRI images. The obtained filtering structures may be provided with similar weighting and adaptive structures as described herein.

### Model of Speckle Noise

In this section a speckle model is introduced. According to an exemplary embodiment, the observation statistics may be derived using a Rayleigh model. Assuming that the speckle is fully developed, the multiplicatively corrupted backscattered signal may be modeled as:

g(i,j)=f(i,j).η(i,j), i=1,2, . . . ,M_{R}, and j=1,2, . . . ,M_{C} (12)

where g(·, ·), f(·, ·) and η(·, ·) denote the observed noisy image, noise-free image, and fading variable, respectively. The fading variable is modeled as a stationary random process independent of f, with γ_{η}=E{η(i,j)}=1, where γ and E{·} denote the mean and the statistical expectation. Also, M_{R} and M_{C} denote the number of rows and columns in the observed 2-D image, respectively.

It may be shown that fully developed speckle, in the multiplicative formulation, may be well modeled by the Rayleigh probability density function (pdf) as:

$${ψ}_{η} ( x ) = \frac{x}{{σ}_{η}^{2}} exp ( - \frac{{x}^{2}}{2 {σ}_{η}^{2}} ) \qquad ( 13 )$$

where σ_{η} is the shape parameter. The raw moments of Rayleigh distribution may be given by:

$${γ}_{η}^{j} = E \{ {η}^{j} \} = {2}^{j / 2} Γ ( 1 + \frac{j}{2} ) {σ}_{η}^{j} \qquad ( 14 )$$

where r(·) is the Gamma function.

Although an exemplary embodiment uses a Rayleigh model in order to derive an exemplary ML filter, it is contemplated that other models may be used. For example, K models, homodyned K, Nakagami, Generalized Nakagami and Rician inverse Gaussian distributions may also be used. It is understood that the use of other models may not provide a closed-form solution.

### Derivation of ML Filter Based on Multiplicative Model of Speckle Noise

The estimation of f(i, j) may be established as a parameter estimation problem where the robust maximum likelihood approach is adopted. Define Ω to be a set of indices defining an observation window of samples from which f(i, j) is to be estimated. For small window sizes, f(i, j) may be assumed constant, i.e., f(i, j)≈β for ∀(i,j)∈Ω. Thus, the estimation of f(i, j) reduces to estimating β from the {g(i, j):(i, j)∈Ω} random variables. Accordingly, the despeckling problem may be formulated as a statistical parameter estimation problem.

In an exemplary embodiment, the {g(i, j):(i, j)∈Ω} values may be Rayleigh distributed with raw moments:

$$\begin{matrix}{γ}_{g}^{j} = E \{ {β}^{j} {η}^{j} \} \\ = E \{ {β}^{j} \} E \{ {η}^{j} \} \\ = {2}^{j / 2} Γ ( 1 + \frac{j}{2} ) {σ}_{η}^{j} {β}^{j} \\ = {2}^{j / 2} Γ ( 1 + \frac{j}{2} ) {σ}_{g}^{j}\end{matrix} \qquad \begin{matrix}( 15 ) \\ ( 16 ) \\ \\ ( 17 ) \\ \\ ( 18 )\end{matrix}$$

where σ_{g}=σ_{η}β, implying that the g(i, j)'s are Rayleigh distributed with parameter σ_{g}.

The ML estimate of σ_{g} may be given by

\hat{σ}_{g}=arg max_{β}ψ(g|σ_{g}) (19)

where g denotes the g(i, j) pixel values in arranged in a vector format. The solution to eq. (19) may be determined as:

$${\hat{σ}}_{g} = {( \frac{1}{2 ‖ Ω ‖} {\sum }_{( i , j ) ∈ Ω} {g}^{2} ( i , j ) )}^{1 / 2} \qquad ( 20 )$$

where ∥·∥ denotes the cardinality of Ω. For instance, a 3×3 window is given by Ω={(i, j)|−1≦i, j≦1} and ∥Ω∥=9.

The ML estimate of f(i, j) may be found using the invariance of the ML estimate:

$$\begin{matrix}\hat{β} = {{\hat{σ}}_{g} ( {σ}_{η} )}^{- 1} & ( 21 ) \\ ⇒ \hat{f} ( i , j ) = {( \frac{1}{2 ‖ Ω ‖ {σ}_{η}^{2}} {\sum }_{( i , j ) ∈ Ω} {g}^{2} ( i , j ) )}^{1 / 2} & ( 22 )\end{matrix}$$

where the final result uses the assumption that {f(i, j):(i, j)∈Ω}≈β.

As shown in eq. (22), the ML estimator contains the term 2σ_{η}². This term uses a tuning parameter α_{MUL}. Let α_{MUL}=2σ_{η}² be the tuning parameter for the multiplicative model. The filter estimate for the multiplicative model can be expressed as:

$$R \text{-} {ML}_{MUL} Filter = \hat{f} ( i , j ) ( α ) = {( \frac{1}{α ‖ Ω ‖} {\sum }_{( i , j ) ∈ Ω} {g}^{2} ( i , j ) )}^{1 / 2} \qquad ( 23 )$$

where the \hat{f}(i,j)(α_{MUL}) notation is introduced to show the dependency on α_{MUL}.

### Derivation of ML Filter Based on Homomorphism Approach

In an alternate embodiment, the multiplicative model of the speckle-corrupted signal of eq. (12) may be converted to an additive model using the known-in-the art homomorphism approach:

log(g(i,j))=log(f(i,j))+log(η(i,j)) (24)

where log(·) denotes the natural logarithm. Denote \tilde{x}≡log(x). The above additive model reduces to

\tilde{g}(i,j)=\tilde{f}(i,j)+\tilde{η}(i,j) (25)

For small window sizes \tilde{f}(i,j), where i and j span the pixels in the moving window, can be assumed constant, β≈\tilde{f}(i,j). Thus, the estimation of \tilde{f}(i,j) reduces to estimation of location parameter in \tilde{η}(i,j) statistics. Accordingly, the despeckling problem may be formulated as a statistical location estimation problem. The class of ML type estimators (M-estimators) of location, developed in the theory of robust statistics, are of fundamental importance in the development of robust signal processing techniques. The ML estimate of β, in this case, may be given by:

$$\hat{β} = {argmax}_{β} [ {\prod }_{k = 1}^{N} {ψ}_{\tilde{η}} ( {\tilde{g}}_{k} - β ) ] \qquad ( 26 )$$

where ψ_{\tilde{η}}(·), \tilde{g} and N denote the density function of \tilde{η}, the pixel values in the moving window arranged in a vector form, and the number of pixels in the window. The density function of random variable \tilde{η} may be determined as described below.

Note that \tilde{η}=log(η). It can be determined that

φ_{\tilde{η}}(t)=φ_{η}(exp(t)) (27)

where φ_{\tilde{η}}(·) and φ_{η}(·) denote the distribution functions of \tilde{η} and η, respectively. This implies that

ψ_{\tilde{η}}(t)=ψ_{η}(exp(t))exp(t) (28)

The density function of \tilde{η} may be computed by replacing eq. (13) in eq. (28) as:

ψ_{\tilde{η}}(t)=(σ²)⁻¹ exp(2t)exp(−exp(2t)/2σ²) (29)

The ML estimate, shown in eq. (26), may be formulated as:

$$\hat{β} = {argmax}_{β} [ {\prod }_{k = 1}^{N} \frac{1}{{σ}^{2}} exp ( \frac{4 {σ}^{2} ( {\tilde{g}}_{k} - β ) - exp ( 2 ( {\tilde{g}}_{k} - β ) )}{2 {σ}^{2}} ) ] \qquad ( 30 )$$

Eliminating the constants redundant to the maximization problem and taking the log reduces the above ML estimate to:

$$\hat{β} = {argmin}_{β} [ {\prod }_{k = 1}^{N} ( exp ( 2 ( {\tilde{g}}_{k} - β ) ) - 4 {σ}^{2} ( {\tilde{g}}_{k} - β ) ) ] \qquad ( 31 )$$

Note that the above gives the estimate for β≈\tilde{f}(i,j)=log(f(i,j)). The estimate for the current pixel, f(i, j), may thus be given by exponentiating the value minimizing the above cost function. The despeckling ML filter output operating on homomorphic samples may thus be defined as the exponential of the value minimizing the above cost function.

Because the convexity of a function guarantees a global minimum, the convexity of the derived cost function may be analyzed. The cost function minimized by the homomorphic despeckling filter may be denoted as:

$$Q ( β ) = {\sum }_{k = 1}^{N} ( exp ( 2 ( {\tilde{g}}_{k} - β ) ) - 4 {σ}^{2} ( {\tilde{g}}_{k} - β ) ) \qquad ( 32 )$$

It can be shown that the second derivative of the cost function, Q″(β) is:

$${Q}^{″} ( β ) = {\sum }_{k = 1}^{N} 4 exp ( 2 ( {\tilde{g}}_{k} - β ) ) \qquad ( 33 )$$

Note that exp(x)>0 for all x>−∞, implying that Q″(β)>0. The second derivative of the cost function, Q″(β), is thus always positive implying that Q(β) is a convex function.

Note that the cost function minimized by the exemplary ML despecking filter, (eq. (31)), contains the term 4σ_{η}². This term uses a tuning parameter α_{ADD}. Let α_{ADD}=4σ_{η}² be the tuning parameter for the additive model. The filter estimate for the additive model can be expressed as:

$$R \text{-} {ML}_{ADD} Filter = \hat{β} ( α ) = {argmin}_{β} {\sum }_{k = 1}^{N} exp ( 2 ( {\tilde{g}}_{k} - β ) ) - α ( {\tilde{g}}_{k} - β ) \qquad ( 34 )$$

where \tilde{β}(α_{ADD}) is introduced to show the dependnecy of the estimate on α_{ADD}.

### Conventional Filtering

A type of conventional filter for despeckling is the mean-type filter, for example, J. S. Lee, “Speckle suppression and analysis for synthetic aperture radar,” Optical Engineering, vol. 25, no. 5, pp. 636-643, 1986 (defined herein as the Lee filter). The mean-type filter typically forms an output image by computing a linear combination of the center pixel intensity in a filter window with the average intensity of the window. The mean-type filter typically achieves a balance between averaging (in homogeneous regions) and the identity filter (where edges and point features exist). This balance typically depends on the coefficient of variation inside the moving window.

Another conventional mean-type filter includes, for example, V. S. Frost, J. A. Stiles, K. S. Shanmugan, and J. C. Holtzman, “A model for radar images and its application to adaptive digital filtering for multiplicative noise,” IEEE Transactions on Pattern Analysis and Machine Intelligence, vol. PAMI-4, pp. 157-165, 1982 (defined herein as the Frost filter), that typically strikes a balance between averaging and the all-pass filter. In this case, the balance may be achieved by forming an exponentially shaped filter kernel that can vary from a basic averaging filter to an identity filter on a point-wise, adaptive basis. The response of the Frost filter typically varies locally with the coefficient of variation. In the low coefficient of variation case, the filter is more average-like, while in the high coefficient of variation case, the filter attempts to preserve sharp features by not averaging.

Another type of conventional filter includes the median filter, for example, T. Loupas, W. N. Mcdicken, and P. L. Allen, “An adaptive weighted median filter for speckle suppression in medical ultrasound images,” IEEE Transactions on Circuits and Systems, vol. 36, pp. 129-135, 1989, may be used for despeckling due to a robustness against the impulsive-type noise and for edge-preserving characteristics. Other known-in-the-art filters include estimation-based theory based gamma-maximum a posteriori (Γ-MAP), anisotropic diffusion based speckle reducing anisotropic diffusion (SRAD), for example, Y. Yu and S. T. Acton, “Speckle reducing anisotropic diffusion,” IEEE Transactions on Image Processing, vol. 11, no. 11, pp. 1260-1270, 2002 and wavelet-theory based GenLiK, for example, A. Pizurica, W. Philips, I. Lemahieu, and M. Acheroy, “A versatile wavelet domain noise filtration technique for medical imaging,” IEEE Transactions on Medical Imaging, vol. 22, no. 3, pp. 323-331, March 2003. In addition, extended versions of the Lee and Frost filters are known to locally alter performance based on induced averaging when the local coefficient of variation is below a lower threshold, performing an all-pass (identity) filter above a higher threshold and when the coefficient of variation is between the two thresholds, computing a balance between averaging and identity operations.

The present invention is illustrated by reference to a number of examples. The examples are included to more clearly demonstrate the overall nature of the invention. These examples are exemplary, and not restrictive of the invention.

### EXAMPLE OF NOISE ATTENUATION CAPABILITY OF EXEMPLARY R-ML_{MUL} FILTER

### A. Estimation Variance

The noise attenuation capability of an estimator is an important measure of estimator performance. Noise attenuation can be measured by an estimator's second central moment. It can be shown that the variance of the exemplary R-ML_{MUL} filter is:

$$Var ( \hat{f} ) = \frac{{β}^{2}}{4 ‖ Ω ‖} \qquad ( 35 )$$

Consider the output variance of known-in-the-art mean-type estimators and median-type estimators:

$$\begin{matrix}Var ( \hat{f} ) = \frac{4 - π}{2 ‖ Ω ‖} {σ}_{η}^{2} {β}^{2} & ( 36 ) \\ Var ( \hat{f} ) = \int {x}^{2} {ψ}_{\hat{f}} ( x ) d x - {( \int x {ψ}_{\hat{f}} ( x ) d x )}^{2} where & ( 37 ) \\ {ψ}_{\hat{f}} ( x ) = \frac{N !}{K ! K !} {ψ}_{g} ( x ) {( {φ}_{g} ( x ) )}^{K} {( 1 - {φ}_{g} ( x ) )}^{K} & ( 38 )\end{matrix}$$

with K=((N−1)/2) and φ_{g} denoting the cumulative density function (CDF) of g.

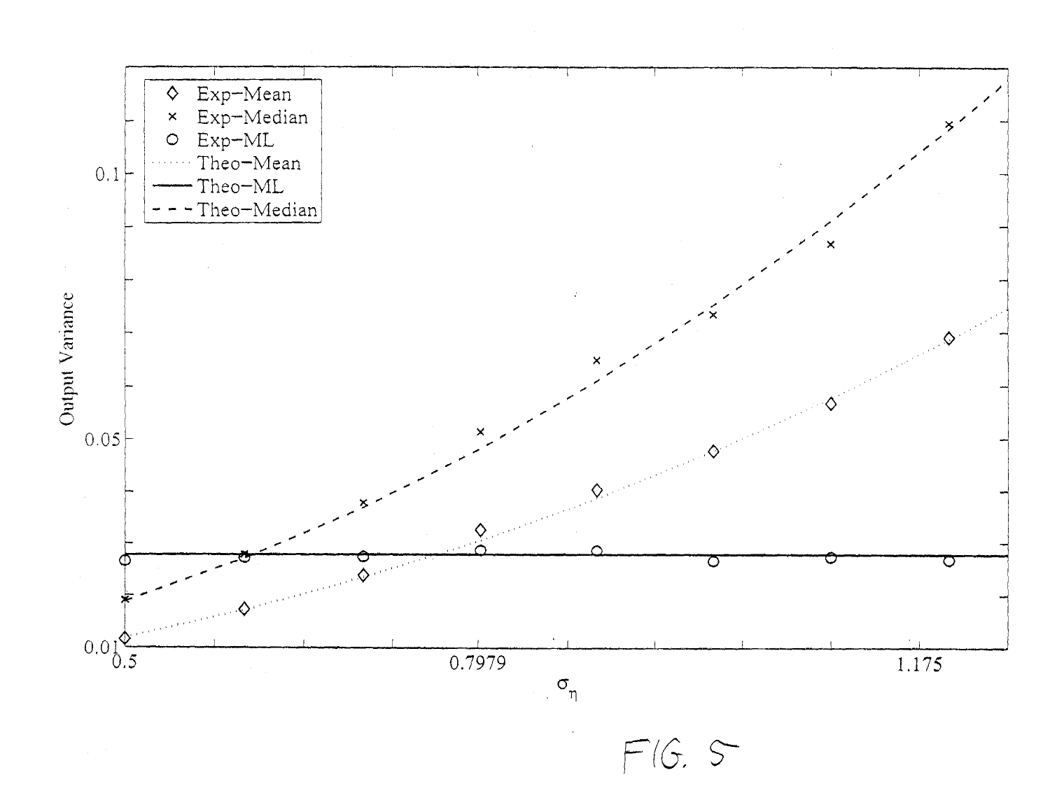

The output variances of these commonly utilized estimators are compared through an illustrative example. A constant 1-D signal with unit amplitude, β=1, and 10000 samples is utilized as the desired signal. The signal is multiplicatively corrupted by Rayleigh distributed noise samples with varying σ_{η} parameter. The noisy observations are processed with mean, median and the exemplary R-ML_{MUL} estimators. The observation window length is set as ∥Ω∥=9, because typical despeckling methods utilize a 3×3 window. The variances of the output signals are recorded and plotted in FIG. 5 along with the theoretical results. It is clear that the experimental results follow the theoretical results and that the exemplary ML estimation technique outperforms the conventional mean and median estimators. Recall that the corrupting speckle process is assumed unit mean (E{η}=1) in ultrasound imaging, indicating that σ_{η}=\sqrt{2/π}≈0.7979. Note that for this critical case, the exemplary ML based filtering provides the best noise attenuation compared to the conventional mean and median estimators. In addition, the performance gain provided by the exemplary algorithm increases with σ_{η}.

### B. Estimation Mean

A second important criteria for an estimator is mean preservation. It can be shown that the mean of the exemplary R-ML_{MUL} estimator can be simplified to:

$$\begin{matrix}E \{ \hat{f} \} = \sqrt{{β}^{2} - \frac{1}{4 ‖ Ω ‖} {β}^{2}} \\ = β \sqrt{\frac{4 ‖ Ω ‖ - 1}{4 ‖ Ω ‖}} \\ = β\end{matrix} \qquad ( 39 )$$

Thus, the exemplary ML based estimator is mean preserving, i.e., it is an unbiased estimator.

Consider next the first moment of mean and median estimators. The expected value of the mean estimator may be shown as:

$$E \{ \hat{f} \} = {σ}_{η} \sqrt{\frac{π}{2}} {γ}_{f} \qquad ( 40 )$$

The mean estimator is unbiased when the corrupting noise is unit mean, but biased in all other cases. The expected value of the median estimator may be shown as:

E{\hat{f}}=φ_{g}⁻¹(½) (41)

where Ψ_{g}⁻¹(·) denotes inverse distribution function of g. It is however easy to show that

φ_{g}⁻¹(x)=βσ_{η}(−2 log(x))^{1/2} (42)

where the assumption that β≈{f(i,j):(i,j)∈Ω} may be used. Evaluation of the above for ½ reveals E{\hat{f}}≈1.1774σ_{η}β. This indicates that median-type estimators do not preserve the mean except in the isolated σ_{η}=0.8493 case, which differs from the unit mean assumption case (σ_{η}=0.7979).

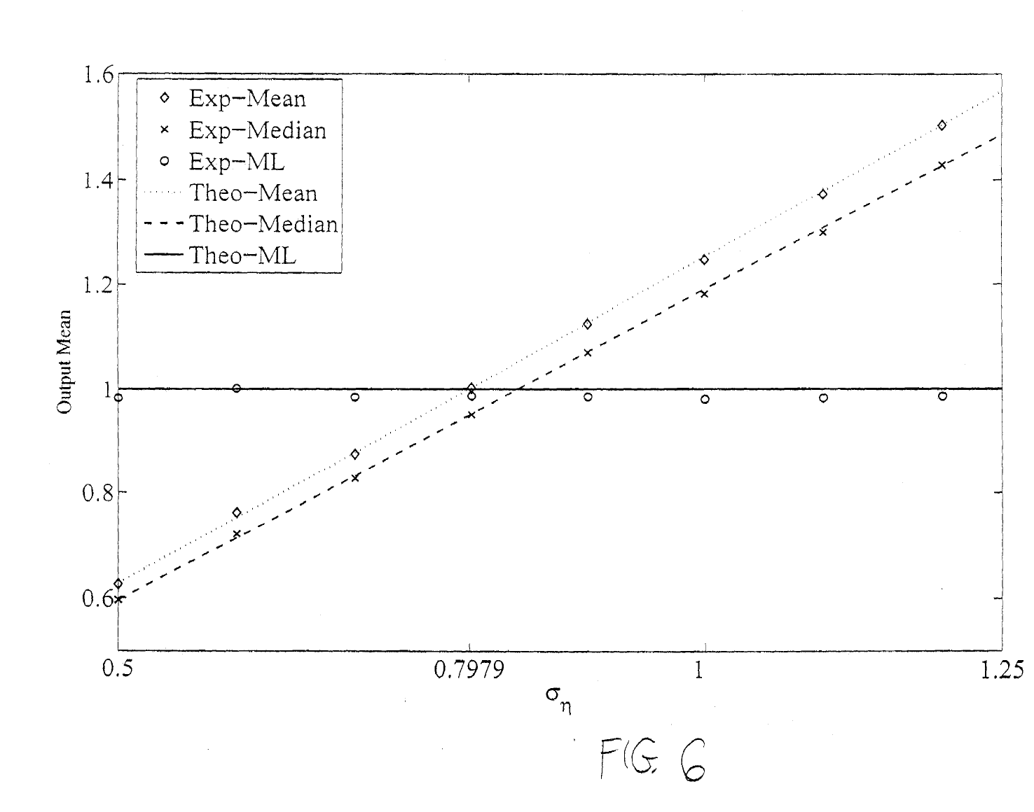

The output means of these commonly utilized estimators are compared through an illustrative example. A constant signal with unity amplitude, β=1, and length 10000 may be used as the desired signal. The signal is multiplicatively corrupted by Rayleigh distributed noise samples with varying σ_{η} parameter. The noisy observations are then processed with the mean, median and exemplary ML estimators utilizing a N=9 observation window length. The means of output signals are recorded and plotted in FIG. 6. It is clear that the exemplary estimation technique is unbiased, regardless of the corrupting noise parameter. The mean estimator, however, is unbiased only when E{η}=1, which is denoted as σ_{η}=\sqrt{2/π}≈0.7979 in FIG. 6. Note that, as expected from the theoretical results, the bias of the mean estimator increases with the spread parameter. The median estimator is biased for all corruption parameter other than the σ_{η}=0.8493 case and, like the mean estimator, the bias increases with σ_{η}.

### EXAMPLE OF EXEMPLARY R-ML_{MUL} FILTER PERFORMANCE WITH SIMULATED SPECKLE

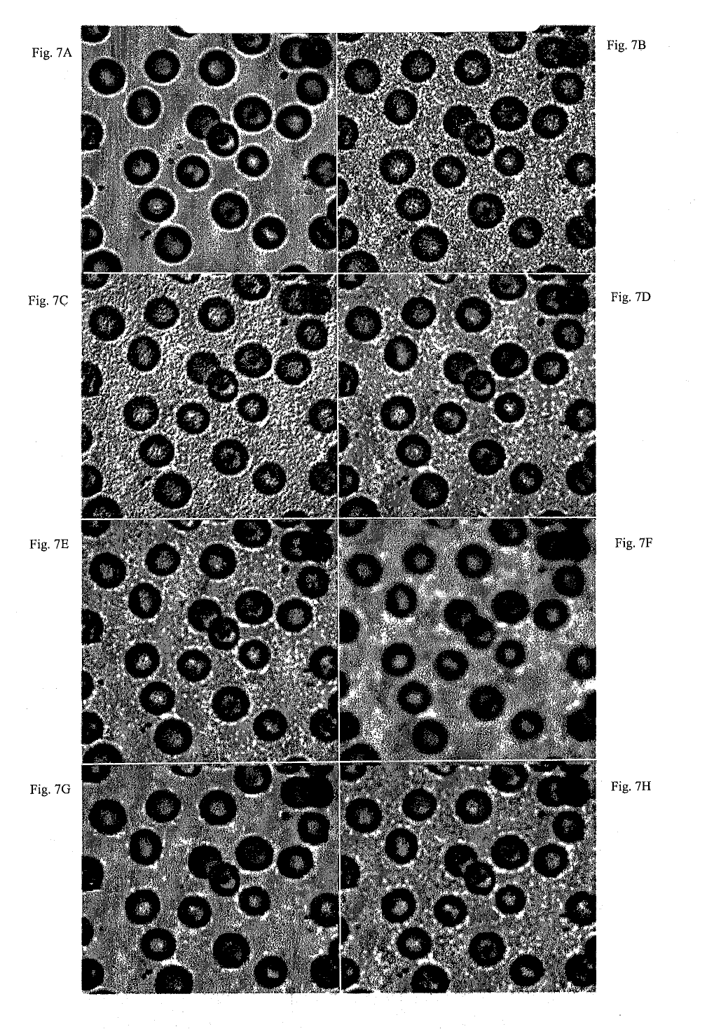

The “blood” image (265×272) provided by MATLAB™ is used to generate the image without speckle noise depicted in FIG. 7A. Realistic spatially correlated speckle noise in ultrasound images may be simulated by lowpass filtering a complex Gaussian random field and taking the magnitude of the filtered output. The lowpass filtering is performed by averaging the complex values in a 3×3 sliding window. The resulting speckled blood image is depicted in FIG. 7B. The noisy blood image is processed with the Lee, Median, Γ-MAP, SRAD, GenLik and exemplary R-ML_{MUL} filters with window sizes 3×3, the results of which are shown in FIGS. 7C, 7D, 7E, 7F, 7G and 7H respectively. In this example, an exemplary tuning parameter is set to a constant, α=2σ²=2(\sqrt{2/π})²=4/π. In addition, the threshold for the local coefficient of variation is set to \sqrt{2/π}.

Although SRAD filter output is effective in background noise suppression, the output is very smooth and appears brighter than the noise-free image. The GenLik filter output is also effective in noise suppression with better edge preservation qualities than the SRAD filter output. There are, however, artificial effects introduced onto the output that disrupt the homogeneousness of the image. It is clear from the images that the exemplary R-ML_{MUL} structure provides the best performance in the sense of noise suppression and image detail preservation.

In addition to the subjective visual results, quantitative results are tabulated in Table 1 for uniform and edge areas. The mean, μ, standard deviation, ν, and universal quality index, Q:

$$Q = \frac{4 {σ}_{yg} \overline{y} \overline{g}}{( {σ}_{g}^{2} + {σ}_{y}^{2} ) ( {\overline{y}}^{2} + {\overline{g}}^{2} )} \qquad ( 43 )$$

where g, y, (̅·̅)̅, and σ_{yg}, denote the input image, output image, the mean intensity and cross-correlation, respectively, are given. The best quality index Q=1, is achieved if and only if y=g. The lowest quality index of Q is −1. The quality index models any distortion as a combination of three different factors: loss of correlation, luminance distortion, and contrast distortion.

TABLE 1
MEAN AND STANDARD DEVIATIONS BEFORE AND AFTER
FILTERING FOR A UNIFORM (20 × 56) (1:20, 35:90) AND
AN EDGE AREA

| | Uniform Areas | | | Edge Areas | | |
|---|---|---|---|---|---|---|
| | μ | ν | Q | μ | ν | Q |
| Orig | 153.68 | 5.69 | — | 120.69 | 52.23 | — |
| Noisy | 152.64 | 33.99 | 0.0594 | 118.98 | 59.31 | 0.9105 |
| Lee | 152.32 | 31.42 | 0.0610 | 117.81 | 59.11 | 0.8460 |
| Median | 148.11 | 21.39 | 0.0986 | 115.76 | 52.85 | 0.9447 |
| Γ-MAP | 152.52 | 19.18 | 0.1165 | 119.26 | 52.07 | 0.9479 |
| SRAD | 168.09 | 9.81 | 0.1795 | 127.95 | 34.85 | 0.5156 |
| GenLik | 152.17 | 8.56 | 0.1568 | 120.10 | 46.55 | 0.9494 |
| R-ML | 152.49 | 15.81 | 0.1447 | 120.12 | 51.08 | 0.9518 |

A review of the quantitative results in Table 1 shows that the Γ-MAP filter provides better noise attenuation than the Median filter, while the median filter outperforms the Lee filter under the same criteria. The SRAD filter, as expected, shows an undesired shift in the output in both smooth and edge areas. Also noticeable in the SRAD and GenLik filters cases is that the standard deviation of the edge area is smaller than that of the original noise-free image due to the extra smoothing. When Q is considered, it is clear that the exemplary R-ML_{MUL} filter provides the best performance in the edge area amongst the tested algorithms. The SRAD filter, however, outperforms the tested algorithms according to this statistic in background areas due to the produced smooth output. Although there is a clear shift at the output, this only marginally affects the Q measure. The tabulated quantitative results corroborate the subjective visual results in that the exemplary R-ML_{MUL} filtering structure strikes the best balance between edge preservation and noise suppression.

### EXAMPLE OF R-ML_{MUL} FILTER TUNING PARAMETER EFFECT ON OBSTETRICAL ULTRASOUND DATA

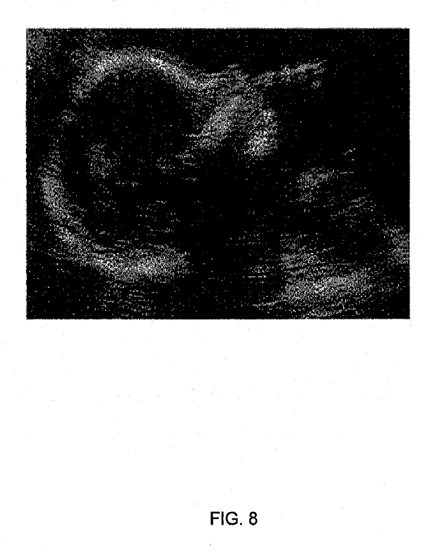

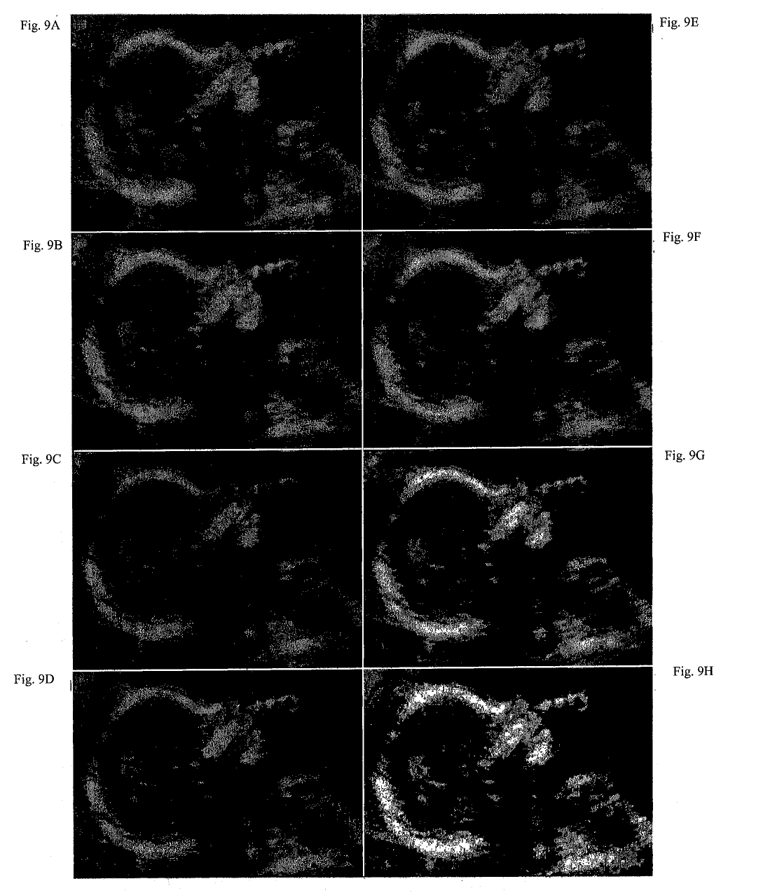

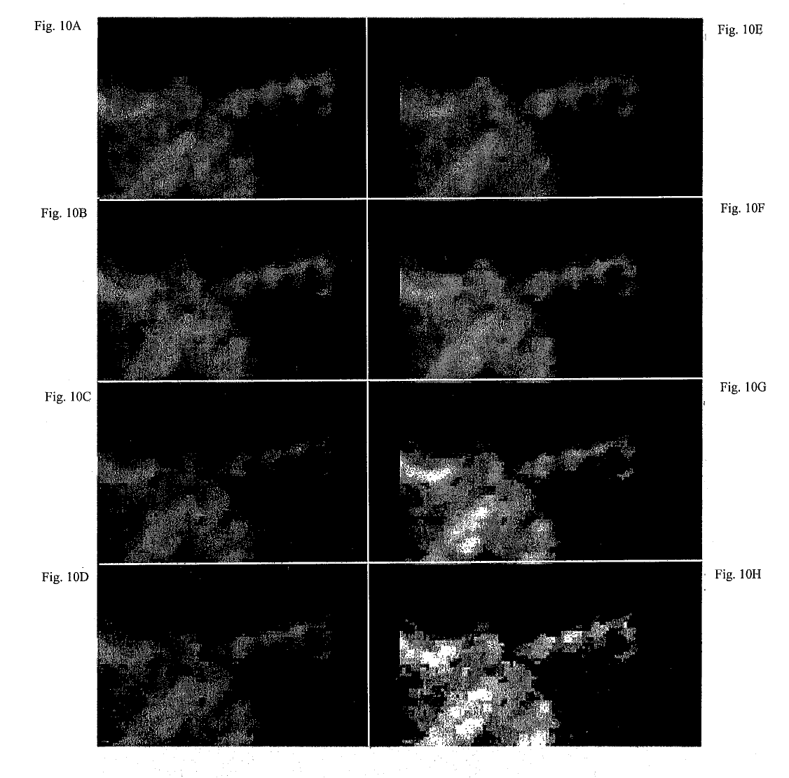

A real noisy ultrasound image with size 161×216 is considered in FIG. 8. In this example, the threshold for the local coefficient of variation is set to \sqrt{2/#}. The obstetrical ultrasound image depicted in FIG. 8 is processed with an exemplary R-ML_{MUL} filter with varying α parameters in order to visualize the tuning parameter effect. As discussed above α_{E} and α_{S} are denoted as the tuning parameter corresponding to detail (heterogeneous) and smooth (homogenous) areas, respectively of the ultrasound image. The exemplary R-ML_{MUL} restored ultrasound images utilizing window size 3×3 and varying a parameters, are given in FIGS. 9A-9H. An enlarged version of the results are shown in FIGS. 10A-10H. The top left and top right images correspond to the uniform fixed parameter case (α=4/π). In this fixed case, although the results are better, as shown in the previous “Blood” example, than the Lee, median, Γ-MAP, SRAD and GenLik methods, the filtering structure provides excessively smooth results that do not differentiate between edge and smooth areas. To more appropriately address the varying image characteristics, we investigate the effect of the tuning parameter in both edge and smooth areas. The coefficient of variation is used to locally determine the homogeneous/heterogeneous characterization of the observation samples. The left columns in FIGS. 9 and 10 show the effect of the varying the α_{S} parameter when α_{E} is fixed to 4/π. As expected, increasing α_{S} tends the filter to the min filtering operation in smooth areas, yielding significant noise smoothing in background areas. The right column, in contrast, shows the effect of the varying the α_{E} parameter when as is fixed to 4/π. Decreasing α_{E} tends the exemplary R-ML_{MUL} filtering to the max operation in the image detail areas, which enhances edges. Intermediate α_{S} and α_{E} values, thus, yields exemplary ML filters with desirable detail enhancement and noise attenuation characteristics.

### EXAMPLE OF PERFORMANCE COMPARISON OF R-ML_{MUL} FILTER ON OBSTETRICAL ULTRASOUND DATA

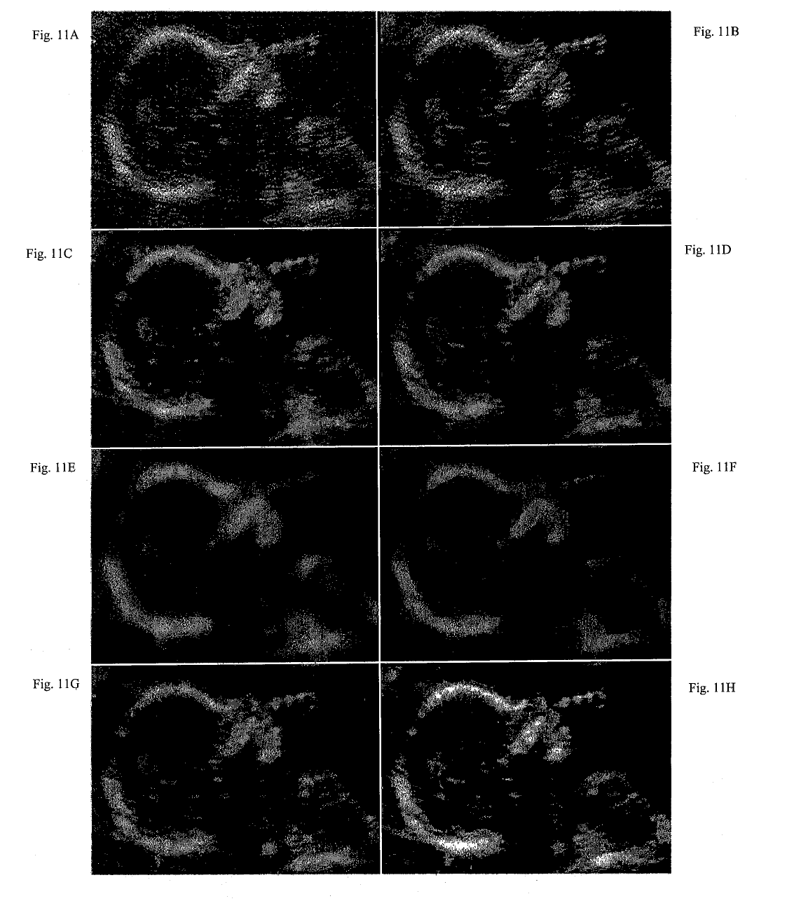

The performances of the Lee, Median, Γ-MAP, SRAD, GenLik, R-ML_{MUL} and adaptive R-ML_{MUL} filters are compared utilizing the real obstetrical ultrasound image in the previous example, and shown again in FIG. 11A. In this example, the threshold for the local coefficient of variation is set to \sqrt{2/π}. This image allows performance evaluations under various conditions since it contains edges with high contrast and uniform areas. The results of the Lee, Median, Γ-MAP, SRAD, GenLik, R-ML_{MUL} and adaptive R-ML_{MUL} filters (α_{S}=2.0 and α_{E}=0.75) are given in FIGS. 11B, 11C, 11D, 11E, 11F, 11G and 11H, respectively. Note that the Lee filter output preserves the image details and edges. Noise components are, however, not sufficiently suppressed since they are significant and observable in the filter output. The median filter suppresses the noise slightly better than the Lee filter in uniform areas. Signal distortion and smoothing effects are, however, notable in the median output. The Γ-MAP filter provides good noise attenuation and smoothing, but it is also clear that the edges are significantly smoothed in the Γ-MAP filter output. The SRAD and GenLik filters clearly provide significant noise suppression, with the cost being excessive smoothing of details, which is especially apparent in the SRAD filter output. Although the constant a parameter R-ML_{MUL} filter provides the desired noise suppression, smoothing effects in edge areas are still noticeable. The adaptive R-ML_{MUL} filter, however, provides the best joint noise attenuation and detail enhancement, thereby achieving the two main objectives in ultrasound image enhancement. Also provided for evaluation are enlarged versions of a section of the images that contains both edge and smooth areas (1:60,90:190).

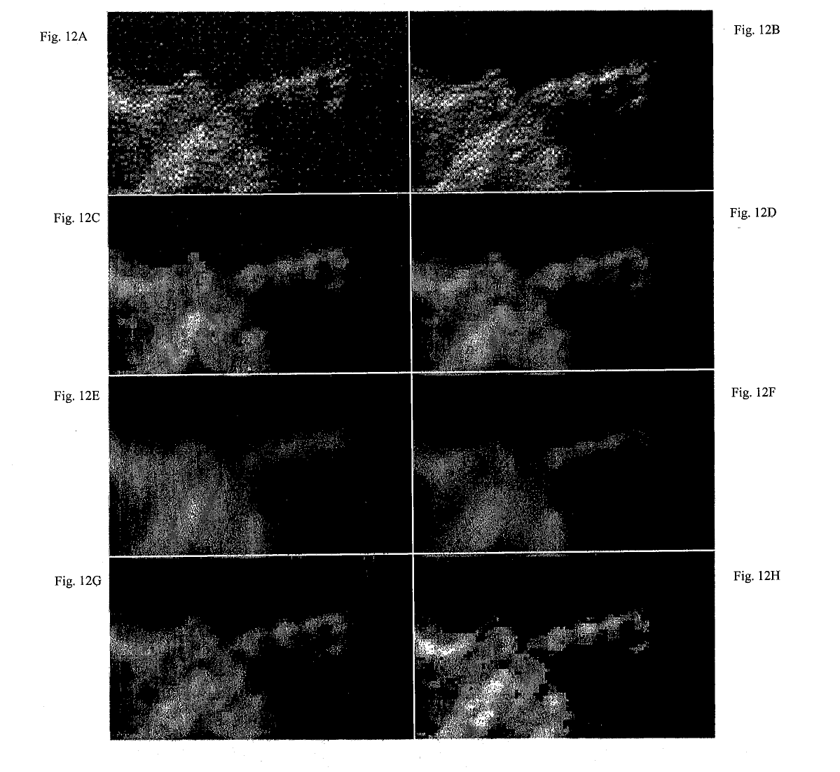

The zoomed-in original Ultrasound image and Lee, Median, Γ-MAP, SRAD, GenLik, R-ML, and adaptive R-ML_{MUL} filter outputs are given in FIGS. 12A-12H. The effectiveness of R-ML_{MUL} filter is even more pronounced in these figures, especially the adaptive R-ML_{MUL}, which significantly attenuates the noise components while simultaneously enhancing the details.

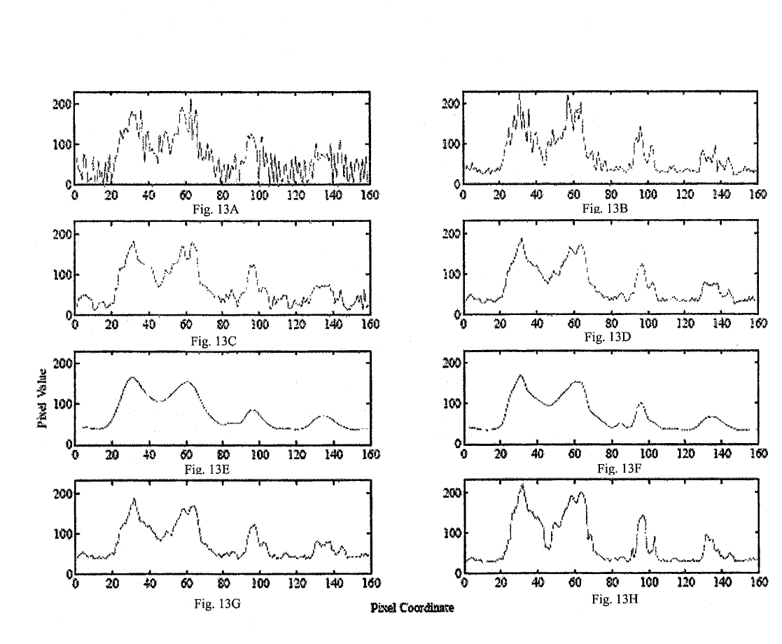

To more closely evaluate the output from each filter, consider a single scan line running through the image. FIGS. 13A-13H show one scan column of the original and processed ultrasound images. The figure shows the original ultrasound image, Lee, Median, Γ-MAP, SRAD, GenLik, Γ-ML_{MUL} and adaptive Γ-ML_{MUL} filter outputs. An examination of the scan line shows that, although the Lee filter output tends to preserve the edges, the filtered output contains a significant level of noise. The median filter provides better noise attenuation and edge preservation than the Lee filter, but the output image is significantly distorted. The Γ-MAP filter performs significantly better than the Lee and Median filters in the sense of noise attenuation, but at the cost of noticeably smoother edges. SRAD and GenLik filter outputs appear almost noise-free with the resulting cost being a significant loss of sharp-transition detail. The adaptive Γ-ML_{MUL} filter strikes the best balance between noise attenuation and detail preserving while simultaneously enhancing edge information. Notably, the sharp edge transitions are preserved and, in fact enhanced, by the Γ-ML_{MUL} yielding a crisper result than compared algorithms.

### EXAMPLE OF PERFORMANCE COMPARISON OF Γ-ML_{MUL} FILTER ON HIGHER RESOLUTION ULTRASOUND DATA

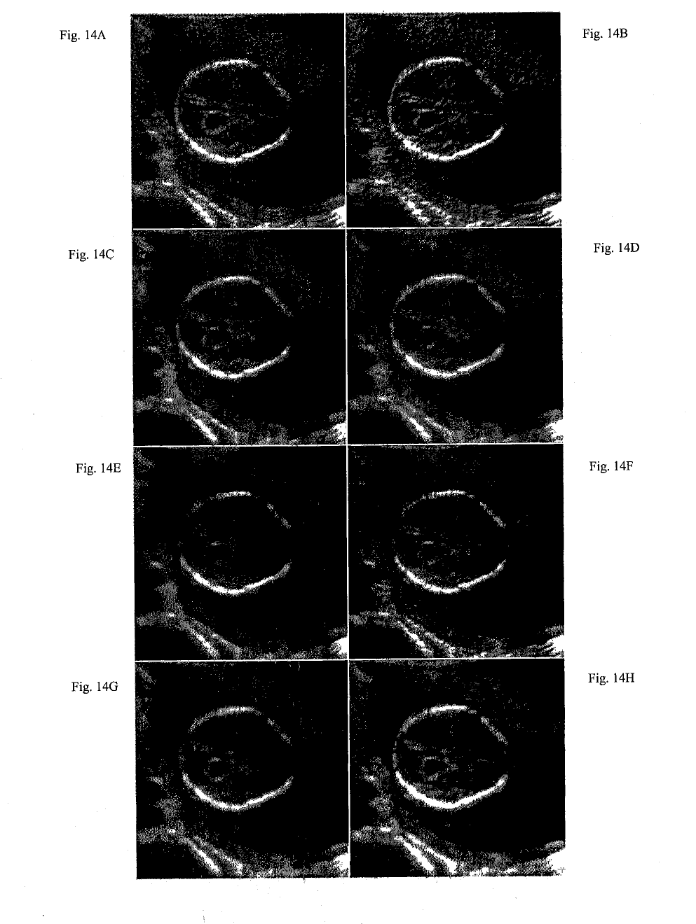

Filter performances are also tested on the 300×300 ultrasound images depicted in FIG. 14A. The ultrasound image is processed with the Lee, Median, Γ-MAP, SRAD, GenLik, Γ-ML_{MUL} and adaptive Γ-ML_{MUL} filters (α_{S}=2.0 and α_{E}=0.75), the results of which are given in FIGS. 14B, 14C, 14D, 14E, 14F, 14G and 14H, respectively. In this example, the threshold for the local coefficient of variation is set to \sqrt{2/π}. The higher resolution of this image makes the selection of a larger window appropriate and all methods are implemented with a 5×5 window. Observations similar to the previous cases can be drawn. That is, the Lee filter tends to the identity filter in edge areas and to the mean filter in smooth regions. The noise attenuation, however, is not sufficient. The median filter provides slightly better noise attenuation and edge preservation, while the Γ-MAP, (especially) SRAD and GenLik filters provide better noise smoothing than both the Lee and Median filters. Unfortunately, Γ-MAP, (especially) SRAD and GenLik filters significantly smooth edges, causing contrast and detail loss. The adaptive Γ-ML_{MUL} filter provides the best overall noise attenuation and edge enhancement, yielding a sharper output.

### EXAMPLE OF PERFORMANCE EVALUATION OF EXEMPLARY SPATIALLY WEIGHTED R-ML_{MUL} FILTER

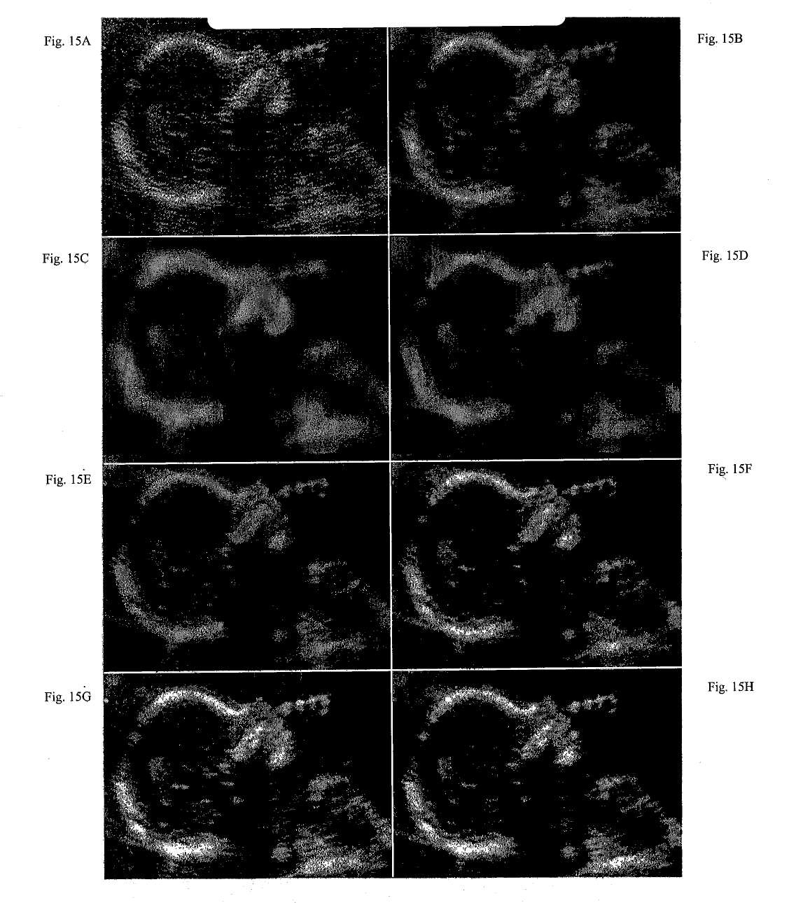

The weighted R-ML_{MUL} estimator is evaluated through an illustrative example. The obstetrical ultrasound image depicted in FIG. 15A is processed with Γ-MAP, SRAD, GenLik, R-ML_{MUL}, adaptively tuned R-ML, center weighted R-ML_{MUL} (CWR-ML), and adaptive center weighted R-ML_{MUL} (ACWR-ML) estimators, FIGS. 15B-15H. In this example, the threshold for the local coefficient of variation is set to \sqrt{2/π}. In the center weighting formulation, only the center sample in the observation window is assigned a non-unit weight, and all other samples are treated equally (uniformly weighted). Increasing the center weight produces less smoothing but greater features preservation. The weighting kernel in this case may be defined as:

$$h = [ \begin{matrix}1 & 1 & 1 \\ 1 & 5 & 1 \\ 1 & 1 & 1\end{matrix} ] \qquad ( 43 )$$

Also, the ACWR-ML is defined such that it reduces to R-ML_{MUL} in homogenous areas to provide the most noise attenuation, and reduces to the CWR-ML in heterogeneous areas, to preserve image details. Note that the performance of ACWR-ML can be further enhanced utilizing varied α_{S} and α_{E} values.

An examination of the results in FIGS. 15A-15H shows that the CWR-ML estimator preserves the ultrasound image detail well, with the cost being noise enhancement in smooth background areas. The undesirable noise enhancement in uniform regions is effectively addressed by the adaptive structure of the ACWR-ML filter, which provides good noise attenuation in background areas and preserves the edges and details present in the underlying ultrasound image. Indeed, the introduction of spatial weights enables correlations amongst input samples to be exploited. This is especially desired, for instance, when the image has directional information that is to be preserved or enhanced.

### EXAMPLE OF EXEMPLARY R-ML_{ADD} FILTER PERFORMANCE WITH SIMULATED SPECKLE

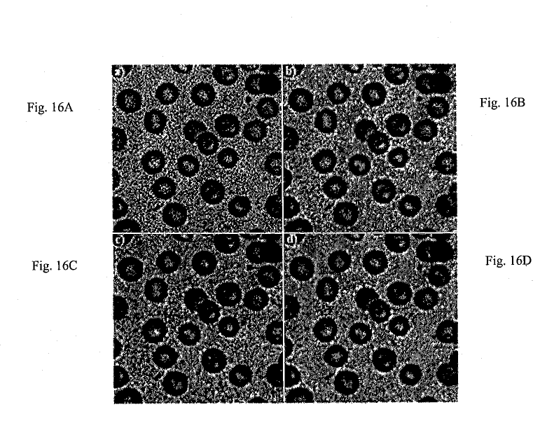

The “blood” image (265×272) provided by MATLAB™ is used to simulate the speckle effect. Each pixel is multiplied by a random value generated according to the Rayleigh probability distribution of mean one, σ=\sqrt{2/π}. The speckled blood image is depicted in FIG. 16A. The noisy blood image is processed with the Lee, median and exemplary R-ML_{ADD} filters, the results of which are shown in FIGS. 16B, 16C and 16D, respectively. It is clear that the exemplary R-ML_{ADD} structure provides the best performance in terms of noise suppression and image detail preservation.

In addition to the visual results, quantitative results are tabulated in Table 2 for uniform and edge areas. The mean, μ, standard deviation, γ, and standard deviation over mean ratio, γ/μ, are given. The median filter provides noise attenuation better than the Lee filter, but, introduces bias to the image. The exemplary R-ML_{ADD} filtering structure provides the best noise attenuation and preserves the mean in both uniform and edge area cases.

TABLE 2
Mean and Standard Deviations Before and After Filtering For A
Uniform (20 × 55) (1:20, 35:90) and An Edge Area
(30 × 25)(10:40, 75:100)

| | Uniform Areas | | | Edge Areas | | |
|---|---|---|---|---|---|---|
| | μ | γ | γ/μ | μ | γ | γ/μ |
| Orig | 153.68 | 4.87 | 0.03 | 120.69 | 52.71 | 0.43 |
| Noisy | 152.19 | 77.64 | 0.51 | 117.25 | 83.34 | 0.71 |
| Lee | 152.01 | 38.82 | 0.25 | 117.99 | 59.08 | 0.50 |
| Median | 146.59 | 31.44 | 0.21 | 110.57 | 54.23 | 0.49 |
| R-ML | 151.91 | 23.32 | 0.15 | 117.70 | 51.79 | 0.44 |

### EXAMPLE OF PERFORMANCE COMPARISON OF R-ML_{ADD} FILTER ON OBSTETRICAL ULTRASOUND DATA

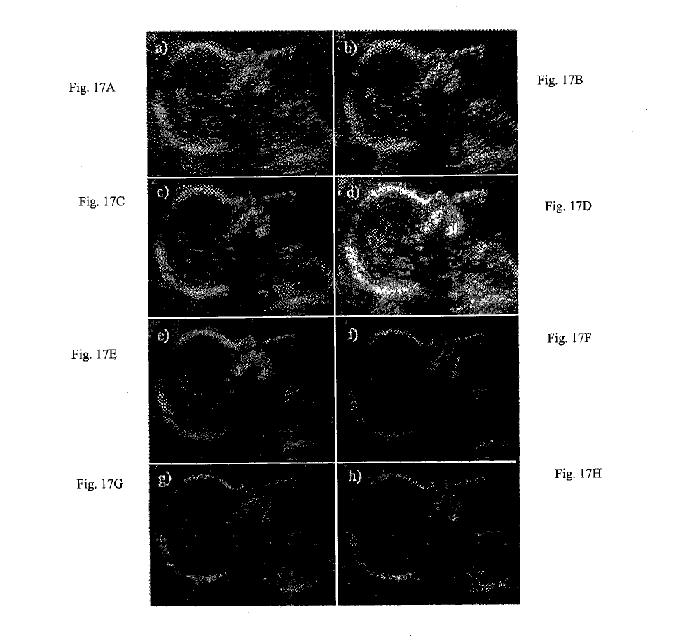

The performances of conventional and R-ML_{ADD} filters are also compared on the real ultrasound baby image depicted in FIG. 17A. This image illustrates performance evaluations for various working conditions because it contains edges with highly contrast characteristics and uniform areas. The results of the Lee and median filters are given in FIGS. 17B and 17C, respectively. Note that the Lee filter output is sharper than the original image. However, noise components are not sufficiently suppressed since they are significantly observable in the filter output. The median filter suppresses the noise slightly better than the Lee filter in uniform areas. Ringing artifacts, signal distortion and smoothing effects are however notable.

The ultrasound image is also processed with the exemplary R-ML_{ADD} filtering structure with varying α_{ADD}. The results corresponding to α_{ADD}=0.4, 0.8, 1.2, 1.6, 2.0 are given in FIGS. 17D, 17E, 17F, 17G and 17H, respectively. The results show that the smaller values tend to emphasize ultrasound image features as well as noise. The higher values of α_{ADD}, in contrast, yield robust structures and significant noise reduction with slight degradation in image detail. An inspection of images shows that the intermediate values produce results superior to conventional methods (Lee and Median filtering), where the exemplary R-ML_{ADD} filter yields more robust results while preserving the image detail.

Although the invention has been described in terms of systems and methods for enhancing an image exhibiting speckle noise, it is contemplated that one or more components may be implemented in software on microprocessors/general purpose computers (not shown). In this embodiment, one or more of the functions of the various components may be implemented in software that controls a general purpose computer. This software may be embodied in a computer readable carrier, for example, a magnetic or optical disk, a memory-card or an audio frequency, radio-frequency, or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for enhancing an image exhibiting speckle noise, the method comprising:
a) receiving the image exhibiting the speckle noise;
b) estimating a coefficient of variation in a part of the received image;
c) selecting either a detail tuning parameter or a smooth tuning parameter based on the estimated coefficient of variation;
d) configuring a maximum likelihood (ML) filter with the selected tuning parameter; and
e) applying the configured ML filter to the part of the received image.

2. The method according to claim 1, wherein the ML filter estimates the speckle noise based on a Rayleigh distribution.

3. The method according to claim 1, wherein the ML filter is generated without modeling the received image.

4. A computer readable carrier including a computer program that causes a computer to perform the method according to claim 1.

5. The method according to claim 1, further comprising the step of generating a spatial weighting corresponding to samples of the part of the received image based upon a correlation among the samples, wherein step d) further configures the ML filter with the generated spatial weighting and step e) applies the spatially weighted configured ML filter to the part of the received image.

6. The method according to claim 5, further comprising the step of adjusting the applied spatial weighting.

7. The method according to claim 1, wherein the coefficient of variation determines whether the part of the received image represents a detail area or a background area, and step c) selects the detail tuning parameter when the part of the received image represents the detail area and selects the smooth tuning parameter when the part of the received image represents the background area.

8. The method according to claim 7, wherein the detail tuning parameter adjusts an edge enhancement of the part of the received image and the smooth tuning parameter adjusts a noise suppression of the part of the received image.

9. The method according to claim 7, wherein when the part of the area represents the detail area, the method includes the step of generating a spatial weighting corresponding to samples of the part of the received image based upon a correlation among the samples, wherein step d) further configures the ML filter with the generated spatial weighting and step e) applies the spatially weighted configured ML filter to the part of the received image.

10. The method according to claim 1, further comprising repeating steps b)-e) for at least one other part of the received image, thereby enhancing the received image.

11. The method according to claim 10, further comprising applying a moving window to the received image to select the at least one other part.

12. The method according to claim 10, further comprising the step of displaying the enhanced image.

13. The method according to claim 12, further comprising adjusting the detail tuning parameter to provide an edge enhancement of the received image, based on the displayed image.

14. The method according to claim 12, further comprising adjusting the smooth tuning parameter to provide noise suppression of the received image, based on the displayed image.

15. A system for enhancing an image exhibiting speckle noise, the system comprising:
an input port configured to receive the image exhibiting the speckle noise, the received image including a plurality of parts;
an estimator configured to estimate coefficients of variation corresponding to the parts of the image received from the input port;
a storage configured to store a detail tuning parameter and a smooth tuning parameter;
a maximum likelihood (ML) filter configured to filter each of the parts of the received image exhibiting the speckle noise, the ML filter configured for each of the parts of the received image based on a selected tuning parameter; and
a processor configured to select, for each of the parts of the received image, either the detail tuning parameter or the smooth tuning parameter from the storage as the selected tuning parameter based on the corresponding estimated coefficients of variation received from the estimator and to configure the ML filter with the selected tuning parameter,
wherein the configured ML filter filters the received image to enhance the received image.

16. The system according to claim 15, further comprising a spatial weighting generator for generating a spatial weighting corresponding to samples in at least one part of the received image, the spatial weighting based upon a correlation among the respective samples in the at least one part of the received image, wherein the processor further configures the ML filter with the spatial weighting corresponding to the at least one part of the received image.

17. The system according to claim 16, further comprising a display configured to display at least one of the detail tuning parameter, the smooth tuning parameter, the spatial weighting, the received image, or the filtered image.

18. The system according to claim 16, further comprising a control interface to adjust at least one of the detail tuning parameter, the smooth tuning parameter, or the spatial weighting.

19. The system according to claim 18, wherein adjusting the detail tuning parameter provides an edge enhancement of the received image.

20. The system according to claim 18, wherein adjusting the smooth tuning parameter provides a noise suppression of the received image.
